(19) United States
(12) Patent Application Publication
(10) Pub. No.: US 2009/0051608 A1
(43) Pub. Date: Feb. 26, 2009

(54) Combination Omnidirectional Antenna and GPS Antenna for Rugged Applications

(75) Inventors: Romer D. Johnson, Oro Valley, AZ (US); Christian H. Carrasco, Tucson, AZ (US); David Yiu, Tucson, AZ (US)

Correspondence Address: QUARLES & BRADY LLP, ONE SOUTH CHURCH AVENUE, SUITE 1700, TUCSON, AZ, 85701-1621, US

(73) Assignee: MODULAR MINING SYSTEMS, INC., Tucson, AZ (US)

(21) Appl. No.: 11/841,544

(22) Filed: Aug. 20, 2007

(51) Int. Cl. H01Q 1/42; H01Q 1/32

(52) U.S. Cl. 343/713; 343/872

(57) ABSTRACT

A mast that includes an omnidirectional antenna disposed therein and a GPS antenna coupled with the mast. Both the omnidirectional antenna and the GPS antenna preferably are protected from the environment, with the omnidirectional antenna being located above the GPS antenna when the mast is positioned vertically.

### BACKGROUND OF THE INVENTION

1. Field of the Invention

The invention relates generally to an omnidirectional antenna and GPS antenna that is coupled with a protective mast.

2. Description of the Related Art

Radio antennas and antennas for receiving Global Positioning System (GPS) signals are a common site on both mobile (e.g., vehicles) and stationary objects (e.g., transmission towers). Sometimes, it is desirable to receive both radio and GPS transmissions at a single location or mobile object.

For a variety of reasons, the reception of both radio waves and GPS transmissions often are accomplished by using two separate antennas. Thus, for example, an automobile often will have both a standard “whip” antenna for radio wave reception and a separate “fin” antenna for GPS reception.

However, even single-unit, multi-frequency antennas are of limited use due to aerodynamic, space, and other considerations. Moreover, a difficulty in producing a combination GPS and radio antenna is that the electronics and mechanical structure for receiving the radio signal can interfere with the performance of the GPS antenna for receiving the GPS signal.

Many antennas are made wholly of wire and/or metal. However, this construction is unsuitable for applications in which the antenna is likely to be subjected to harsh conditions. For example, haul trucks at a mine site are used in rugged terrain and under conditions that tend to bend, corrode, break, an otherwise impair the function of an ordinary metal antenna. Furthermore, exposure of a metal antenna to extra-vehicular sources of electrical current (such as lightning or even overhead power lines in the case of large trucks) can present a safety issue.

Since it is desirable to have antennas at the highest point of an object in order to maximize reception, separate antennas for reception of radio and GPS signals often are placed at the highest part of a vehicle. However, this can lead to interference when both antennas are disposed at a similar height, and having two separate antennas can only increase the cost and time involved in maintaining and repairing antennas that become damaged.

### SUMMARY OF THE INVENTION

The invention relates in general to an antenna that combines a GPS antenna, an omnidirectional antenna, and a protective mast. More particularly, the invention involves an omnidirectional antenna that is at least partially encased by a mast and includes a GPS antenna that is coupled with the same mast and is at least partially encased by a protective cover. The omnidirectional antenna is located above the GPS antenna when the mast is used in its normal vertical position.

Preferably, the cables connected to the omnidirectional antenna and the GPS antenna are housed within the mast so that they also are protected and isolated. Moreover, the mast most preferably is radio frequency (RF) transparent and made of low or non-electrically conductive material.

In one aspect of the invention, the mast is flexible and the mast and protective cover comprise a radome. In other words, the mast and protective cover enable the antennas of the invention to resist bending forces, impacts, ultraviolet light, and all types of inclement weather. Moreover, encasing the antennas of the invention provides a stronger overall structure, as the nesting of the antenna within the mast “reinforces” the mast.

The antennas of the invention are particularly useful in situations involving exposure to rugged conditions. Thus, for example, while exposure to sand, sun, rain, ice, dust, rock impacts, and tree braches would bend/deform, corrode, or break a typical metal antenna, the embodiments of the invention both maintain structural integrity and provide improved multi-reception functionality under harsh conditions.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 is a schematic view of a wireless network utilizing antennas of the prior art.

FIG. 2 illustrates in sectional view a first embodiment of the invention.

FIG. 3 depicts in side elevational view a second embodiment of the invention, with the antenna and GPS receiver being shown inside the mast in phantom line.

FIG. 4 shows a schematic of a haul vehicle with an antenna of the invention mounted in a preferred location.

### DETAILED DESCRIPTION OF THE PREFERRED EMBODIMENTS

The invention relates to providing an omnidirectional antenna and GPS signal-reception antenna in conjunction with a single protective mast. The omnidirectional antenna and GPS antenna components are situated along the mast such that interference is minimized, yet both components can be positioned higher than the object to which they are attached for optimal reception.

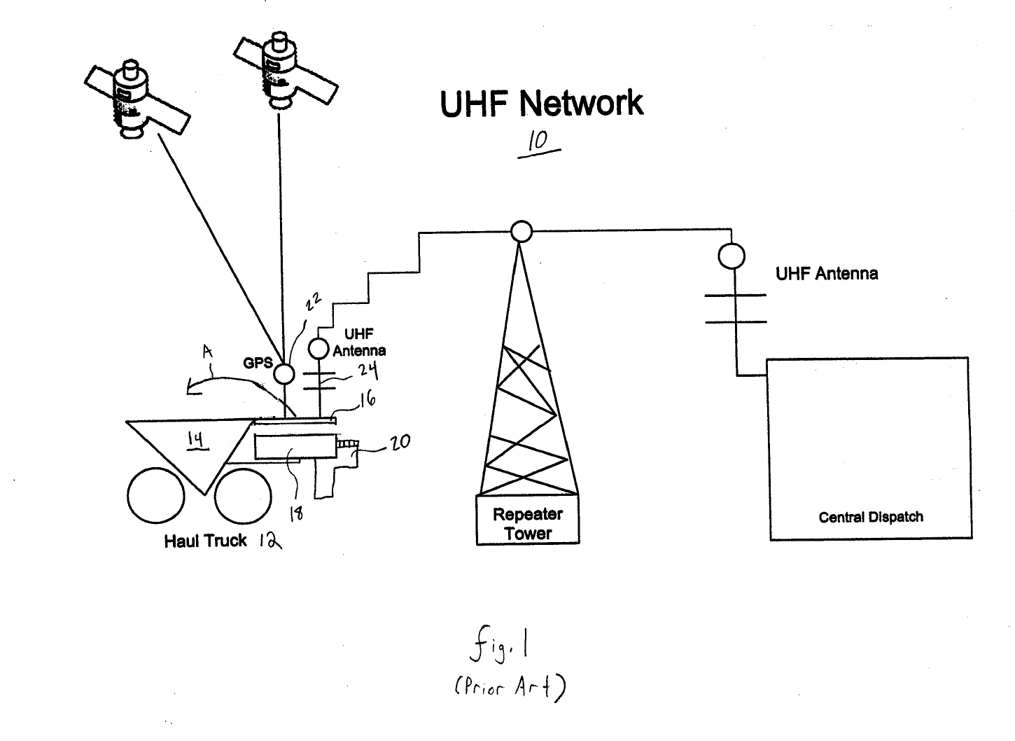

Referring to FIG. 1, the numeral 10 identifies a typical wireless network arrangement involving a haul truck, a repeater tower, and central dispatch in accordance with the prior art. The haul truck 12 includes a dump bed 14 having an overhang 16, a cab 18, a boarding platform and rail 20, a GPS antenna 22 and a UHF antenna 24. As indicated by arrow A, the overhang 16 of dump bed 14 elevates during use. Thus, GPS antenna 22 and antenna 24 will become lower than the overhang 16 during normal operation of truck 12, which can lead to impaired signal reception. Moreover, neither antenna 22 nor antenna 24 are protected from the elements or against impact (e.g., from a rock outcropping or tree branch).

Turning to FIG. 2, an antenna of the invention is shown. The antenna 30 includes a tubular 32 mast containing an omnidirectional antenna 34 and a GPS antenna 36 encased in a protective cover 38 that is coupled to the mast 32. Omnidirectional antennas include, for example, whip, vertical dipole, discone, and horizontal loop antennas. Near the lower end of the mast 32 is a sleeve 40 into which the mast is coaxially disposed and that allows the mast to be adjusted in height as indicated by arrow B.

The receiver 36 is coupled to the mast 32 such that it is below the omnidirectional antenna when the mast is in a vertical position. This positioning of the antenna 36 and antenna 34 on the same mast has been found to lessen interference and yet provide for optimal reception capabilities. Preferably, antenna cable 42 and antenna cable 44 are disposed inside the mast 32, which is substantially non-conductive (i.e., little or no electrical conductivity).

Also preferably, the mast 32 and/or protective cover 38 is flexible and a radome. A radome is a structural, weatherproof enclosure used to protect an antenna. What distinguishes a radome structure from other structures is that the material used in building the radome allows a relatively unattenuated electromagnetic signal between the antenna inside the radome and outside equipment. In other words, RF transparency is characteristic of a radome. Using conventional whip antenna materials (i.e. steel, aluminum, etc.) would block most if not all of the antenna signal. Moreover, a radome protects the surfaces of the antenna from the effects of environmental exposure (i.e., wind, rain, sand, UV, ice, etc.). Fiberglass or an acetal resin engineering plastic, such at that sold under the DELRIN brand name, are examples of flexible radome materials.

FIG. 3 illustrates a second embodiment of the invention, wherein a GPS antenna 50 and omnidirectional antenna 52 are integrated interior to a single radome mast 54. For added protection and insulation, cable 56 connected to the omnidirectional antenna 52 and cable 58 connected to the antenna 50 also are housed within the mast 54. A power source, if needed, also may be included inside or outside the mast as shown. The mast 54 further includes a mounting means (such as clamps 60) at a lower end thereof.

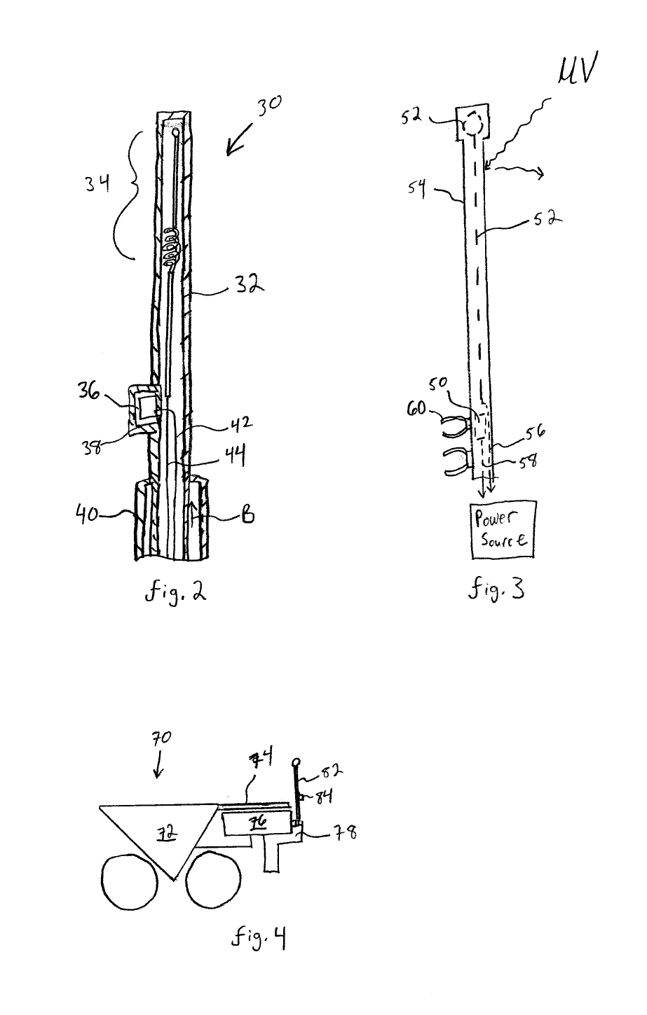

FIG. 4 depicts an embodiment of the invention in use on a vehicle, haul truck 70. The truck has a dump bed 72 with an overhang 74, a cab 76, and a boarding platform and rail 78. Because mounting an antenna on any part of the dump bed (including overhang 74) would result in the problems incurred by the vehicle of FIG. 1, an omnidirectional antenna encased in a mast 82 and a GPS antenna 84 coupled to the mast 82 below the omnidirectional antenna are secured to a portion of railing 78.

Thus, the mast 82 is secured to vehicle 70 such that both the antenna 82 and the antenna 84 are higher than the vehicle 70 and overhang 74.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A combination antenna, comprising:
a GPS antenna;
an omnidirectional antenna; and
a mast, wherein the omnidirectional antenna is at least partially encased by said mast, the GPS antenna is coupled with said mast and at least partially encased by a protective cover, and the omnidirectional antenna is located above the GPS antenna when said mast is vertically disposed.

2. The antenna of claim 1, wherein said mast and protective cover comprise a radome.

3. The antenna of claim 1, wherein said mast is flexible.

4. The antenna of claim 1, wherein said mast is adjustable in height.

5. The antenna of claim 1, wherein said mast further includes a mounting means at a lower end thereof.

6. The antenna of claim 1, wherein said GPS antenna and omnidirectional antenna are integrated into a single mast.

7. The antenna of claim 1, wherein cables connected to said omnidirectional antenna and said GPS antenna are housed within said mast.

8. The antenna of claim 1, wherein the mast is substantially non-electrically conductive.

9. A combination antenna, comprising a tubular mast containing an omnidirectional antenna and a GPS antenna coupled to the mast below said omnidirectional antenna when said mast is vertically disposed.

10. The antenna of claim 9, wherein said GPS antenna is at least partially encased by a protective cover.

11. The antenna of claim 10, wherein said mast and protective cover comprise a radome.

12. The antenna of claim 9, wherein said mast comprises a radome.

13. The antenna of claim 9, wherein said mast is flexible.

14. The antenna of claim 9, wherein said mast is adjustable in height.

15. The antenna of claim 9, wherein said mast further includes a mounting means at a lower end thereof.

16. The antenna of claim 9, wherein said GPS antenna and omnidirectional antenna are integrated inside a single mast.

17. The antenna of claim 9, wherein cables connected to said omnidirectional antenna and said GPS antenna are housed within said mast.

18. The antenna of claim 9, wherein the mast is substantially non-electrically conductive.

19. A vehicle having a tubular, non-conductive mast containing an omnidirectional antenna and a GPS antenna coupled to the mast below said omnidirectional antenna when said mast is vertically disposed.

20. The vehicle of claim 19, further comprising a dump bed, an overhang, a cab, a boarding platform and a rail, wherein said mast is secured to the rail of said vehicle such that both the GPS antenna and the omnidirectional antenna are higher than the vehicle at all times during normal vehicle operation with the exception of an elevated bed for dumping.
